(19) United States
(12) Patent Application Publication
(10) Pub. No.: US 2007/0071383 A1
(43) Pub. Date: Mar. 29, 2007

(54) Retainer Structure

(76) Inventor: Mikio Kawamura, Kanagawa (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/427,968

(22) Filed: Jun. 30, 2006

(30) Foreign Application Priority Data
Sep. 28, 2005 (JP) P2005-282351

(51) Int. Cl. F16C 33/46

(52) U.S. Cl. 384/614

(57) ABSTRACT

A plate-shaped main body has a first main face and a second main face opposing to each other, and is formed with a through hole connecting the first main face and the second main face thereby forming a first opening at the first main face and a second opening at the second main face. The through hole is adapted to rotatably support a ball therein. A first deformation preventing portion is provided on an inner face of the through hole in the vicinity of the first opening to prevent an edge of the first opening from being deformed when the ball is press-fitted into the through hole through the first opening. A second deformation preventing portion is provided on the inner face of the through hole in the vicinity of the second opening to prevent an edge of the second opening from being deformed when the ball is press-fitted into the through hole through the second opening.

### BACKGROUND OF THE INVENTION

The present invention relates to a retainer structure.

A related art disk drive motor, supported by a motor board, is provided with a thrust ball bearing on which a load generated by magnetic absorption force of a rotor magnet is applied in a thrust direction. The thrust ball bearing includes a rotary wheel (thrust supporting plate on a side of the rotor) fixed to the rotor and rotated together with the rotor, a stationary wheel (thrust supporting plate on a side of a stator) fixed to the top surface of the motor board, a plurality of balls coming in contact with the rotary wheel and the stationary wheel, and a retainer rotatably supporting the balls.

The retainer has a ball supporting portion that rotatably supports the ball having an inner circumferential surface corresponding to an outer surface of the ball, circular openings that are formed on both sides, from which parts of the ball are protruded so as to come in contact with the rotary wheel and the stationary wheel, respectively. The rotary wheel and the stationary wheel are common parts formed in a flat washer shape (ring-shaped plate) with the same thickness. Therefore, the same parts interpose the ball therebetween so as to face each other and come in contact with the ball. The ball is a steel ball or a ceramic ball with high hardness to be generally used in a ball bearing. The rotary wheel and stationary wheel are formed of stainless materials (for example, see Japanese Patent Publication No. 2002-233098A).

The ball is incorporated into the retainer by a general method in which the ball is press-fitted into a ball supporting portion through any circular opening on both sides of the retainer. However, since each angle between the ball supporting portion and both sides of the retainer is an acute angle, inner edges of the circular opening are mechanically weak. As a result, when the ball formed of steel is press-fitted into the ball supporting portion through the circular opening, plastic deformation, such as a burr tends to occur at the inner edge of the circular opening.

To solve the above problem, the other related art retainer structure is provided. As shown in FIGS. 3 and 4, a retainer main body 1 is formed of a ring-shaped plate, and is provided with six ball holding portions 3 in a circumferential direction. Parts of a ball 2 is protruded from the ball holding portions at one side 1a of the retainer main body 1 and the other side 1b by predetermined amount and rotatably holds the ball 2.

The ball holding portion 3 includes a ball supporting portion 4 that has an inner circumferential surface corresponding to the outer surface of the ball 2 and rotatably supports the ball 2, circular openings 5a and 5b that are formed on one side 1a and the other side 1b of the retainer main body 1, from which parts of the ball 2 are protruded, a deformation preventing portion 6 that prevents an inner edge of the circular opening 5a from being deformed when the ball 2 is press-fitted into the ball supporting portion 4 through the inner edge of the circular opening 5a on the one side 1a of the retainer main body 1.

A marker 7 indicating the press-fitting direction of the ball 2 into the ball supporting portion 4 is formed at an outer edge on the one side 1a of the retainer main body 1 by cutting a part of a corner of the outer edge. The retainer main body 1 including the ball supporting portion 3, the deformation preventing portion 6, and the marker 7 is manufactured by molding resin.

On the basis of the indication by the marker 7, the ball 2 is press-fitted into the ball supporting portion 4 only through the circular opening 5a on the one side 1a in which the deformation preventing portion 6 is formed. Accordingly, it is possible to prevent the inner edge of the circular opening 5a from plastic deformation, such as a burr 8.

In the related art retainer structure disclosed in Japanese Patent Publication 2002-233098A, each of the angles between the one side of the retainer and the inner face of the ball supporting portion, and between the other side and the inner face of the ball supporting portion is an acute angle. Therefore, when the ball formed of steel is press-fitted into the ball supporting portion through the circular openings of the one side or the other side of the retainer, plastic deformation, such as a burr may occur at the inner edge of the circular opening through which the ball is press-fitted.

In the related art retainer structure as shown in FIGS. 3 and 4, the deformation preventing portion 6 is not provided at the inner edge of the circular opening 5b on the other side 1b of the retainer main body 1. Therefore, when the ball 2 is press-fitted into the ball supporting portion 4 through the circular opening 5b on the other side 1b, plastic deformation, such as the burr 8 may occur at the inner edge of the circular opening 5b (see FIG. 4). In this configuration, the automation of the press-fitting process cannot be achieved with a simple assembly jig. Therefore, it is difficult to facilitate the automation of a press-fitting process of the ball.

### SUMMARY OF THE INVENTION

It is therefore an object of the invention to provide a retainer structure, in which the ball can be press-fitted into the ball supporting portion from both one side and the other side of the retainer main body without causing plastic deformation, such as a burr at the inner edges of the circular openings, and automation of a press-fitting process of the ball into the ball supporting portion is facilitated, thereby improving productivity and reducing manufacturing costs for molding the retainer main body.

In order to achieve the above-mentioned object, according to the invention, there is provided a retainer structure comprising:

a plate-shaped main body, having a first main face and a second main face opposing to each other, and formed with a through hole connecting the first main face and the second main face thereby forming a first opening at the first main face and a second opening at the second main face, the through hole adapted to rotatably support a ball therein;

a first deformation preventing portion, provided on an inner face of the through hole in the vicinity of the first opening to prevent an edge of the first opening from being deformed when the ball is press-fitted into the through hole through the first opening; and

a second deformation preventing portion, provided on the inner face of the through hole in the vicinity of the second opening to prevent an edge of the second opening from being deformed when the ball is press-fitted into the through hole through the second opening.

With this configuration, the ball can be press-fitted into the through hole through the first opening or the second opening, without causing plastic deformation, such as a burr at the edges of the first and second openings. Therefore, automation of a press-fitting process is facilitated, thereby improving productivity.

Each of the first and second deformation preventing portions may have a face extending in a direction parallel to a central axis of the through hole.

With this configuration, each of the angle between the first main face of the main body and the first deformation preventing portion, the angle between the second main face and the second deformation preventing portion, and the angle between an inner face of the through hole and the first and second deformation preventing portions is no less than 90 degrees. Therefore, when the ball is press-fitted into the through hole through the first opening or the second opening, it is possible to reliably prevent plastic deformation, such as a burr at the respective edges of the first and second openings. As a result, it is possible to ensure the rolling operation of the ball.

The main body may be comprised of resin.

With this configuration, the main body has flexibility. As a result, the ball can be easily press-fitted into the through hole through the first opening or the second opening having a smaller diameter than the through hole, without causing plastic deformation, such as a burr at the edges of the first opening and the second opening. The main body may be manufactured by molding the resin material using a mold. In this case, the through hole is formed from a pin mold part that molds the resin material and then extracted from the resin material.

An appearance of the first main face may be substantially identical with an appearance of the second main face.

With this configuration, the ball can be press-fitted into the ball supporting portion in any direction. Therefore, it is not necessary to provide a marker indicating the press-fitting direction of the ball to the main body. For this reason, it is possible to reduce manufacturing costs of a mold for molding the main body.

A shape and a size of the first opening may be substantially identical with a shape and a size of the second opening.

The first and second deformation preventing portions may be integrally formed with the main body.

The first and second deformation preventing portions may have elasticity such an extent that the first and second deformation preventing portions are deformed when the ball is press-fitted in the through hole.

### BRIEF DESCRIPTION OF THE DRAWINGS

The above objects and advantages of the present invention will become more apparent by describing in detail preferred exemplary embodiment thereof with reference to the accompanying drawings, wherein:

FIG. 1 is a cross-section view of a retainer structure according to an embodiment of the present invention;

FIG. 2 is a cross-section view of the retainer structure showing a state where a ball is incorporated into a main body of the retainer structure.

FIG. 3 is a perspective view of a related art retainer structure; and

FIG. 4 is an enlarged cross-section view along the line IV-IV of FIG. 3.

### DETAILED DESCRIPTION OF THE EMBODIMENTS

Embodiment of the invention will be discussed in detail with reference to the accompanying drawings.

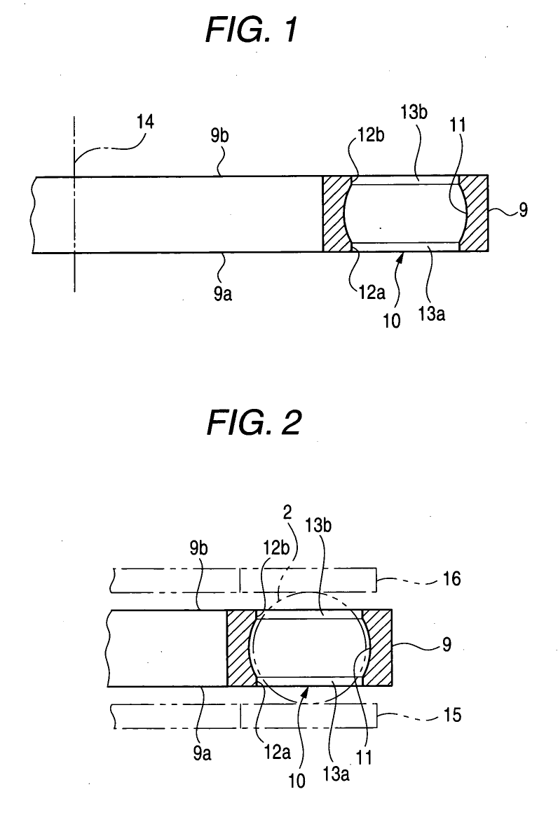

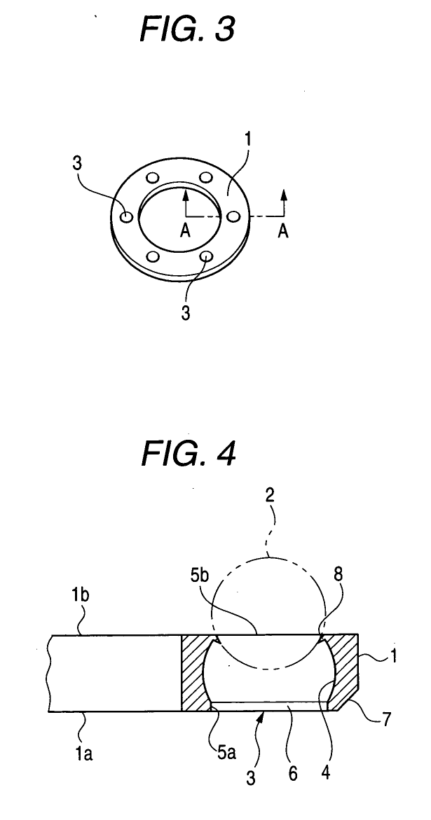

As shown in FIGS. 1 and 2, a retainer main body 9 is formed of a ring-shaped plate with a predetermined thickness, and is provided with a plurality of ball holding portions 10 in a circumferential direction. Each of the ball holding portions rotatably holds a ball 2. The parts of the ball 2 are protruded from one face 9a side and the other face 9b side of the retainer main body 9.

Each of the ball holding portions 10 includes a ball supporting portion 11 having an inner face corresponding to an outer surface of the ball 2 and rotatably supports the ball 2, circular openings 12a and 12b formed on one face 9a side and the other face 9b side of the retainer main body 9 respectively while the parts of the ball 2 are protruded from the circular openings 12a and 12b respectively, and deformation preventing portions 13a and 13b having a predetermined width and provided on inner edges of the circular openings 12a and 12b on one face 9a side and the other face 9b side of the retainer main body 9 and preventing the inner edge of the circular openings 12a and 12b from being deformed after the ball 2 is press-fitted into the ball supporting portion 11. Each of the deformation preventing portions 13a and 13b are integrally formed with the retainer main body 9.

The deformation preventing portion 13a has an inner face connecting one face 9a and the ball supporting portion 11, and the deformation preventing portion 13b has an inner face connecting the other face 9b and the ball supporting portion 11. Each of the inner faces of the deformation preventing portions 13a and 13b is substantially in parallel with a central axis 14 of the ring-shaped plate. In other words, each of the inner faces of the deformation preventing portions 13a and 13b is perpendicular to one face 9a and the other face 9b of the retainer main body 9 respectively. Therefore, each of an angle defined by one face 9a and deformation preventing portion 13a, the other face 9b and deformation preventing portion 13b, ball supporting portion 11 and the inner face of the deformation preventing portion 13a, ball supporting portion 11 and the inner face of the deformation preventing portion 13b is no less than 90 degrees. Accordingly, it is possible to press the ball 2 into the ball supporting portion 11 without causing plastic deformation, such as a burr at the inner edge of each of the circular opening 12a and 12b on one side 9a and the other side 9b of the retainer main body 9. Therefore, it is possible to facilitate automation of pressing the ball 2 into the ball supporting portion 11, thereby improving productivity. In addition, it is possible to ensure the rolling operation of the ball 2.

An appearance of one face 9a of the retainer main body 9 is substantially identical with an appearance of the other face 9b of the retainer main body 9. The shape and size of the ball holding portion 10 as viewed from one face 9a side of the retainer main body 9 are substantially identical with that viewed from the other face 9b side of the retainer main body 9. Therefore, the ball is press-fitted into the ball supporting portion 11 in any direction. For this reason, as shown in FIG. 4, it is not necessary to provide a marker indicating the press-fitting direction of the ball 2 into the ball supporting portion 11 of the retainer main body 9. As a result, it is possible to reduce manufacturing costs of a mold for molding the retainer main body 9.

The retainer main body 9 that includes the ball supporting portion 11, the circular openings 12a and 12b, and the deformation preventing portions 13a and 13b is manufactured by molding a resin material using a mold. In this case, the ball holding portion 10 that is vertically symmetric is formed by molding a resin material into a pin mold part and then by extracting the pin mold part from the resin material. Therefore, the retainer main body 9 including the deformation preventing portions 13a and 13b has elasticity such an extent that the retainer main body is elastically deformed when the ball is press-fitted in the through hole.

As shown in FIG. 2, after being press-fitted into the ball supporting part 11 of the retainer main body 9, the ball 2 comes in contact with a stationary thrust supporting plate 15 and a rotary thrust supporting plate 16 so as to be press-fitted between the stationary thrust supporting plate 15 and the rotary thrust supporting plate 16, thereby forming a thrust ball bearing. For example, the stationary thrust supporting plate 15 is fixed to a stator of a motor, and the rotary thrust supporting plate 16 is fixed to a rotor of the motor. While a thrust load is applied to the balls, the respective balls 2 roll inside the respective ball supporting portion 11 in accordance with the rotation of the rotor. Accordingly, the rotor smoothly rotates.

Although the invention has been described by way of the embodiment, various modifications and changes may be made without departing from the scope and spirit of the invention.

What is claimed is:

1. A retainer structure comprising:
a plate-shaped main body, having a first main face and a second main face opposing to each other, and formed with a through hole connecting the first main face and the second main face thereby forming a first opening at the first main face and a second opening at the second main face, the through hole adapted to rotatably support a ball therein;
a first deformation preventing portion, protruded from an inner face of the through hole in the vicinity of the first opening, and having a first face being continuous with the first main face, a second face being continuous with the inner face of the through hole and a third face connecting the first face and the second face; and
a second deformation preventing portion, protruded from the inner face of the through hole in the vicinity of the second opening, and having a fourth face being continuous with the second main face, a fifth face being continuous with the inner face of the through hole and a sixth face connecting the fourth face and the fifth face,
wherein each of a first angle defined by the first face and the third face, a second angle defined by the second face and the third face, a third angle defined by the fourth face and the sixth face, and a fourth angle defined by the fifth face and the sixth face is no less than 90 degrees.

2. The retainer structure as set forth in claim 1, wherein:
the first angle is 90 degrees; and
the third angle is 90 degrees.

3. The retainer structure as set forth in claim 1,
wherein the main body is comprised of resin.

4. The retainer structure as set forth in claim 1,
wherein an appearance of the first main face is substantially identical with an appearance of the second main face.

5. The retainer structure as set forth in claim 1,
wherein a shape and a size of the first opening are substantially identical with a shape and a size of the second opening.

6. The retainer structure as set forth in claim 1,
wherein the first and second deformation preventing portions are monolithically formed with the main body.

7. The retainer structure as set forth in claim 1,
wherein the first and second deformation preventing portions have elasticity such an extent that the first and second deformation preventing portions are elastically deformed when the ball is press-fitted in the through hole.
